(19) United States
(12) Patent Application Publication
(10) Pub. No.: US 2025/0371290 A1
(43) Pub. Date: Dec. 4, 2025

(54) TITLE INDUSTRY STANDARD OBJECTS INTEGRATION SERVICES PLATFORM AND IMPLEMENTATION

(71) Applicant: Orion Technologies, Inc., PLANO, TX (US)

(72) Inventors: Ben Cork, Sanford, FL (US); Laura Mowrer, St. Petersburg, FL (US); Jeff Canter, McKinney, TX (US)

(73) Assignee: Orion Technologies, Inc., PLANO, TX (US)

(21) Appl. No.: 19/226,859

(22) Filed: Jun. 3, 2025

Related U.S. Application Data
(60) Provisional application No. 63/655,248, filed on Jun. 3, 2024.

(51) Int. Cl. G06F 40/51; G06Q 50/16

(52) U.S. Cl. CPC G06F 40/51; G06Q 50/167

(57) ABSTRACT

The present technology is generally related to a computer-implemented system that provides an online network and host computing device having hardware and software configured to enable the computing device to host an application platform for standardized data objects and processes for transferring property rights and closing real estate transactions.

### FIELD

The present technology is generally related to methods, systems, and apparatuses to provide an object-model driven title microservices platform that enables title processing systems and title plants to interoperate using Application Programming Interface (API) implementation with a high degree of accuracy, efficiency, security, and interoperability, without data loss or misrepresentation.

### BACKGROUND

Presently, the title process in a real-estate transaction involves the exchange of information in a heavily regulated industry that does not have common objects amongst data or other information sources. Although the standards of various industries are publicly available, each standard is unique to its particular industry and does present information in a way that serves the needs of other industries. For example, the mortgage industry has common standards under the Mortgage Industry Standards Organization (MISO), which defines mortgage information standards. However, this does not cover the needs of the title industry.

Thus, there is not currently a way for different standards to be used and implemented within a single interface to facilitate the exchange of information to a user. Therefore, there is a need for the standardization of data objects and processes across varying industries for the transfer of real property rights and when closing real estate transactions. There is also a need to reduce the time and cost associated with developing new applications, as well as the risk of errors or inconsistencies in data exchange.

Lastly, there are numerous independent implementations for each standard due to the fragmentation that arises from multiple business entities and their individual applications, both from a pre-digital and from the pre-internet era. These fragmented implementations between vendors, partners and businesses impact the customer experience due to increased time to transform and transmit data, and leave room for human error. In the age of modern, distributed computing, it thus becomes critical for us to unify, digitize and enable a highly automated degree of both implementation and integration to eliminate redundant implementations, and to preserve both data integrity and efficiency.

### SUMMARY

The present invention provides methods, systems, and apparatuses to provide an object-model driven title microservices platform that enables title processing systems and title plants to interoperate using Application Programming Interface (API) implementation with a high degree of accuracy, efficiency, security, and interoperability, without data loss or misrepresentation.

According to one or more embodiments, A standardized title processing system, comprises a host computing device, a digital platform for standardized data objects and processes for transferring information associated with real property, and one or more provider computing devices. The digital platform is hosted by the host computing device. The one or more provider computing devices are each in communication with the host computing device and the digital platform via one or more networks. The host computing device is configured to: submit a request for information to the one or more provider computing devices; receive a response from each of the one or more provider computing devices with the requested information; analyze a current standard of the retrieved information; translate the retrieved information into a single standardized format; and generate a report comprising the translated information.

In one aspect, the one or more provider computing devices are in each communication with a respective database storing information related to real property.

In another aspect, the host computing device submits the request for information to each of the one or more provider computing devices via an API call.

In another aspect, the stored information related to real property comprises at least one of: chain of title information, tax records, appraisal details, legal records, title information, escrow information, fee information, and events.

In another aspect, the digital platform further comprises a search engine configured to facilitate the exchange of API calls over the one or more networks.

In another aspect, the host computing device further comprises a decision engine module programmed to filter the exchange of standardized information to users.

In another aspect, the digital platform is one of: an application-based platform and a web-based platform.

In another aspect, the request for information comprises a request for Rate and Fee information associated with a vendor of real estate services.

In another aspect, the digital platform is programmed to be integrated with third-party real estate closing platforms.

In another aspect, the digital platform uses one or more application programming interfaces to send and receive API calls to transmit information between the host computing device and the one or more provider computing devices.

In another aspect, the single standardized format is a single source of truth (SSoT).

In another embodiment, a method for generating standardized title reports using information from a plurality of independent information sources comprises: providing a host computing device; accessing, with the host computing device, a digital platform for standardized data objects and processes for transferring information associated with real property; submitting a request for information to one or more data sources; receiving a response from at least one computing device associated with the one or more data sources, the response including the requested information; analyzing a current standard of the requested information contained within the response; translating the requested information into a single standardized format; and generating a title report comprising the translated requested information.

In one aspect, the request is submitted via an API call.

In another aspect, translating the requested information into a single standardized format comprises encoding the requested information as data strings compatible with one or more technology stacks.

In another aspect, the host computing devices comprises one of a desktop computer, laptop, tablet, and mobile device.

The key objective of implementing title industry standard objects (“TISO”) is to unify the definition of common title industry data objects, Transactions, Integrations and Business Processing to provide an Object-model-driven Title Microservices Platform that enables Title Processing Systems and Title Plants to interoperate using an industry-standard OpenAPI implementation with a high degree of accuracy, efficiency, security, and interoperability, without data loss or misrepresentation.

The invention standardizes the data objects and processes for transferring property rights and closing real estate transactions. The standards are publicly available and can be utilized and implemented within applications and products to facilitate the exchange of information. The objects are focused on title, escrow, fees, and events.

Implementation can be accomplished using the following three integration delivery methods: API, Micro UI, or hosted application. Each method builds on the other, creating a more elegant and streamlined solution for users to utilize the services in a way that best suits their business needs and experience.

The invention aims to solve the problem of standardizing and optimizing the exchange of information in a heavily regulated industry that does not have common objects. The invention solves this problem by defining, establishing, and making standards publicly available and accessible. By doing so, the invention ensures that all applications can communicate with each other and share data seamlessly, without requiring any additional effort or resources. This helps to reduce the time and cost associated with developing new applications, as well as the risk of errors or inconsistencies in data exchange. Additionally, the invention promotes greater interoperability and collaboration between different organizations and industries, which can lead to new opportunities for innovation and growth. The standardization of the exchange of information through the public availability, access, and promotion of standards in a heavily regulated industry that does not have common objects is a key feature of the present invention. The objects may be focused on title, escrow, fees, and events. The standards are publicly available and can be utilized and implemented within applications and products to facilitate the exchange of information.

The invention further provides a decision engine that leverages its exchange of standardized data to provide data services to consumers. Based on a consumer's specific needs, the engine matches service requests to providers through configuration and machine learning, optimizing for property location, provider capabilities, price, and consumer preferences. For example, when a title production system requires recording fee data for a real estate transaction, it sends a request into the standard fees decision engine, which evaluates the property address, supported fee service providers that cover that county, a confidence score based on past performance of that service provider, price of the service, and consumer preferences to route that request to the best available service provider. The decision engine uses machine learning technologies based on service provider, results, and consumer feedback to continuously improve its matching and routing logic.

Overall, the invention provides a powerful tool for improving efficiency, reducing costs, and enhancing the quality of products and services within the title industry.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 illustrates an exemplary system constructed in accordance with principles of the present application that provides an object-model driven title microservices platform;

FIG. 2 shows a Unified Modeling Language (UML) class diagram illustrating processes of a Standard Title Object Model in accordance with principles of the present application;

FIG. 3 shows a UML class diagram illustrating further processes of the Standard Escrow Object Model of FIG. 2, in accordance with principles of the present application;

FIG. 4 shows a UML class diagram illustrating processes of the Standard Rates and Fees Object Model in accordance with principles of the present application;

FIG. 5 shows a UML interaction diagram illustrating processes of the System Events Object Model provided by the system 10 to enable asynchronous distributed processing among disparate systems across organizational boundaries using Advanced Message Queuing Protocol (AMQP) in accordance with principles of the present application;

FIGS. 6A-6B depicts how applications may access TISO implementations via integration to direct data exchange API calls or by consuming micro-UI fragments delivered by a TISO API, in accordance with principles of the present application;

FIG. 7 shows a UI implementation of a Standard Title integration, in accordance with principles of the present application;

FIGS. 8A and 8B, show an example API definition using REST standards to facilitate banking transactions backed by the Standard Escrow Data Object in accordance with principles of the present application;

FIG. 8C shows a view of the top-level properties of the schema used in the banking transactions provided by the Standard Escrow integration, in accordance with principles of the present application;

FIG. 9 shows a micro-UI implementation for the Standard Escrow Wire Manager transaction view in accordance with principles of the present application;

FIG. 10 shows an example API definition using REST standards to facilitate the Standard Rates and Fees model as well as a list of schema used in those requests, in accordance with principles of the present application; and

FIGS. 11 and 12 show an implementation of the micro-UI that allows a consumer to interact with the Rates and Fees API in accordance with principles of the present application;

FIG. 13 shows an infrastructure-as-a-service (IaaS) implementation in accordance with principles of the present application;

FIG. 14 shows a platform-as-a-service (PaaS) implementation in accordance with principles of the present application; and

FIG. 15 illustrates an exemplary system constructed in accordance with principles of the present application.

### DETAILED DESCRIPTION

The devices, systems, and methods disclosed herein are for standardizing data objects and processes for transferring property rights and closing real estate transactions.

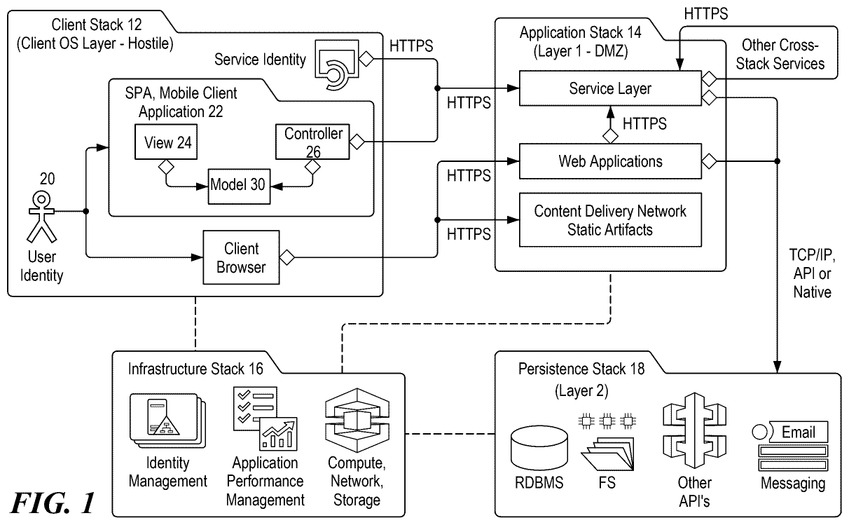

Referring now to the drawings in which like reference designators refer to like elements, there is shown in FIG. 1, a computer-implemented system, designated generally as “10”, that provides a Client Stack 12, Application Stack 14, Infrastructure Stack 16, and Persistence Stack 18. The Client Stack 12 comprises a user or User Identity 20 interacting with a Mobile Client Application (MCA) 22 via a mobile device or other computing device (not shown). The MCA 22 comprises a view, a controller, and model. As described herein, “view 24” may refer to a user-facing display or screen of their mobile or computing device that is responsible for translating the data transfer object into a presentable format as desired by the function being performed. View 24 can implement Localization and Internationalization to do non-mutating transformations of data like currency conversions, language translation, local formatting, etc. View 24 is also two-way. It can be used for data entry and can implement standard validation, for example ensuring that the age of a person is always positive, etc. The same data transfer object can be translated and reused by multiple views to accomplish multiple client functions. In some embodiments, view 24 can also store view-specific model representations of data, locally for efficiency. The controller 26 is a client-side orchestration that is in charge of communicating with the Server-side API. The controller 26 is configured to both detect data transfer object model changes on the client due to user activity and commit the changes to the respective APIs. Additionally, controller 26 is further configured to retrieve data from the respective APIs to enable the application to function. According to one or more embodiments, there several client controllers (not to be confused with the API controller), and each may orchestrate several calls to several APIs to achieve units of work. The model 30 is generally used to store data transfer object data locally to achieve respective functions. The model 30 is updated based on changes made by a client to a data entry. These changes have to persist across several screens/steps that users may perform to achieve a transactional unit.

As shown in FIG. 1, Client Stack 12 comprises a User Identity 20 and a Service Identity. The User Identity 20 communicates with the Application Stack 14 via the MCA 22 or the client browser through the use of Hypertext Transfer Protocol Secure (HTTPS). The Application Stack 14 includes a service layer that leverages the data access layer and implements our business logic in the form of a class library that can be re-used across APIs. The service layer further contains Business Entities-which are higher level compositions of the Data Entities. For example, an actual transaction will contain higher level objects that are composed of more than one Data Entity (or collections of data entities). An actual transaction may involve multiple operations that have to happen across several data entities, but together. Moreover, the Application Stack 14 further comprises web applications and content delivery networks statistic artifacts.

The Client Stack 12 and Application Stack 14 are each in communication with the Infrastructure Stack 16, which comprises identity management, application performance management, and compute, network, and storage. The Application Stack 14 and Infrastructure Stack 16 are further in communication with a Persistence Stack 18 that comprises a relational database management system, file system, other APIs, and messaging functionality.

### Definitions

“Seller” means a person or entity who is selling real property.

“Buyer” means a person or entity who is purchasing real property from a Seller.

“Transaction Party” means the Buyer and Seller, collectively, who are parties to a real-estate transaction.

“Title Order Party[ ]” means one or more parties who are involved in ordering a title search and/or an examination thereof, which may result in the issuance of an evidence of title or delivery of other reports or products in which title records are used. As used herein, double square brackets “[ ]” are introduced to indicate plurality or a collection of objects.

“ActorType” refers to one of a real estate agent, notary, property inspector, property inspector, or the like.

“Actor[ ]” refers to a collection of specific persons or entities who are the real estate agent, notary, property inspector, property inspector, or the like as it pertains to the transaction.

“Escrow Bank” means a third-party financial institution or bank that holds onto money or items until the Buyer and Seller complete their respective tasks to consummate the transfer of real property.

“Lender” means an individual, a public or private group, or a financial institution that makes funds available to a borrower, who may be a person or business, for use in a real-estate transaction, with the expectation that the borrower will repay the funds to the lender.

“Title Underwriter” means a person or entity that authorizes and issues authority for its agents to write title insurance policies.

“Title Company” means a company or other entity that checks the validity of a property's title and, if valid, issues title insurance to that property. The Title Company may also hold and manage money in escrow, with the assistance of an Escrow Agent or Escrow Bank, and can assist in facilitating the transfer of title from the Seller to the Buyer.

“Title Policy” means a form of insurance that protects buyers of real-property from any defects in the title associated with a particular property they are purchasing. The Title Policy may cover any liens, ownership disputes, or other claims that might affect the right to own the property. The Title Policy is issued after the Title Company conducts a title search to ensure that the Seller has the legal right to transfer the title to the subject property to the Buyer.

“Service” means refers to a type of title service to be provider for a particular order, which may be user/application defined. In one or more embodiments, the orders may include but are not limited to ALTA Orders (Owner, Title Guarantee, Mortgagee, Simultaneous, Construction Loan, Other) and/or TX Orders (Owners (residential and nonresidential), Mortgagee, Simultaneous Reissue (Residential), Simultaneous (Non-Residential), Binder, Other).

“Service Type” means the title service requested or provider for a title order (e.g., purchase, refinance, HELOC).

“Title Order Commitment” refers to the document by which a title insurer discloses to all parties connected with a particular real estate transaction all the liens, defects, and burdens and obligations that affect the subject property. The document may provide a list of all requirements that must be met before the Title Company can insure the title or a loan.

“Title Order” means the ordering a title search and/or an examination thereof, which may result in the issuance of an evidence of title or delivery of other reports or products in which title records are used.

“Financial Record[ ]” means a list of loans associated with the real estate transaction.

“Loan” means a sum of money that is borrowed from a Lender with the expectation that the money will be repaid to the Lender.

“MortgageBroker” means an intermediary who brings mortgage borrowers and mortgage lenders together, but who does not use their own funds to originate mortgages.

“Transaction Type” refers to the particular type of real-estate transaction between the Buyer and Seller.

“Transaction” refers to the specific real-estate transaction between the Buyer and Seller.

“Note” means a legal document that sets out all the terms of the transaction between a borrower and their Lender.

“Document” means any separate binary document (e.g., .pdf, .doc, .png, etc.) associated with the title order object. Examples include purchase agreements, wiring instructions, closing protection letters (CPLs), title insurance policies, and photocopies of buyer/seller IDs.

“Property[ ]” means the specific real-estate property or properties that is/are the subject of a transaction between the Buyer and Seller.

“Product[ ]” means the type of product or service being ordered and then provided by an industry service provider, such as those integration partners listed above for information providers. These product names are typically defined by the information provider (ex: County SearchCounty, Search Continuation, CPL, Curative, Document Preparation, eRecording Document, eSign, Estoppel Letter, Fees, Flood Search, Flood Search (LOL), Jacket, Judgment Search, Judgment w/Patriot, Judgment Search Continuation, Lender Order, Lien Search, Marketing, Notary, Order Data Access, Other Documents, Payoff Tracking, Realtor Order, Release Tracking, Stand Alone Patriot Search, Survey, Tax Certificate, Tax Search, Tax Search-Continuation, Tidelands Search, Title Order, Title Search, Wire Fraud Prevention, Zoning Letter).

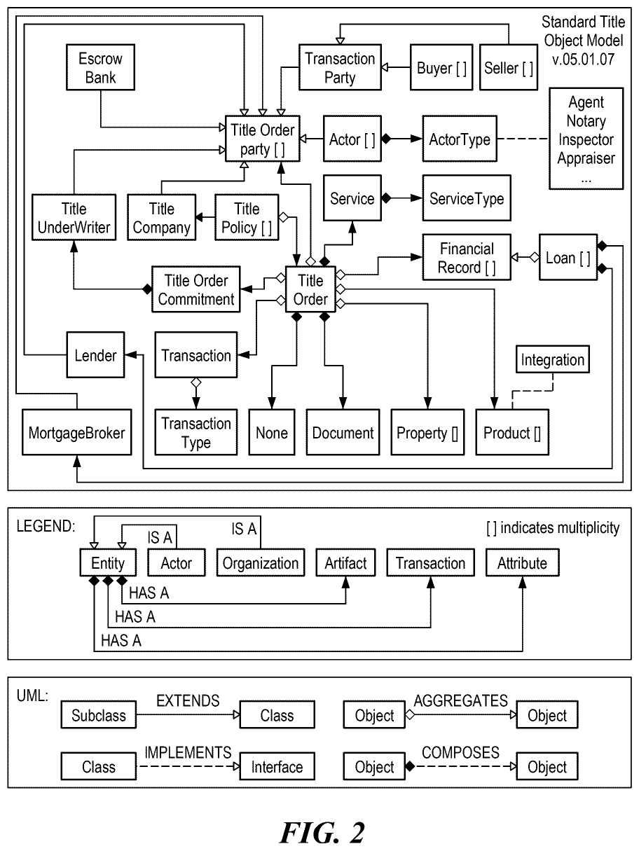

Now referring to FIG. 2, according to one or more embodiments, Client Stack 12, Application Stack 14, Infrastructure Stack 16, and Persistence Stack 18 together provide a platform to enable a user, such as a Title Order Party to conduct a real estate title search and generate a report that retrieves, via API calls over a network, sets of data or objects (such as chain of title, tax records, appraisal details, court house records) from different information providers or data repositories, even when each particular information provider stores its respective data or objects in a common industry standard that is different from the standards used by other information providers. This is because a host computing device is capable of communicating with each information provider via one or more networks, submitting a request for certain data or objects, receiving a response from the information provider with the requested data or objects, analyzing the current standard of the retrieved data or objects, and translating all received data and objects into a single standardized format that is processed and used by the platform for inclusion on the title report. The standardization of the exchange of information through public availability, access, and promotion of standards in a heavily regulated industry that does not have common objects is a component of the present invention. In one or more embodiments, the retrieved data includes attributes, statistics, metrics, and any raw data, associated with title, escrow, fees, and events. The standards are publicly available and can be utilized and implemented within applications and products to facilitate the exchange of information. Further, in some embodiments the system 10 can also include a search engine that allows users of the platform to search and send API calls over the network for various information related to title, escrow, fees, events, etc. The search engine may use keyword searches or an additional “Advanced Search” feature to conduct more narrow searches for specific information. However, it is to be understood that the present system can be implemented, exchanged, and consumed without the use of a search engine. It is also to be understood that an API is just one way of exchanging information among disparate computing infrastructures and is described here as an exemplary embodiment.

As mentioned above, in one or more embodiments the system 10 includes a decision engine or module that leverages its exchange of standardized data to provide optimized data services to customers. Based upon a consumer's specific needs, the decision module may be configured to match service requests to information providers through configuration and machine learning, optimizing for property location, provider capabilities, price, and consumer preferences. It is to be understood that the decision module may be a module within the host computing device or an external module that is in communication with the host computing device. As described herein, the standardization of data may comprise the conversion or mapping of data retrieved from different sources or providers into a consistent or uniform format. In some embodiments, the decision module further includes machine learning capability that maps requests to providers, records the results (e.g., does an instant title search provider return a timely and successful search for a property in a certain state and county), and then may also provide a mechanism for consuming applications/users to provide feedback as to provider results. Machine learning based on user behavior while interacting with the platform then use this data to refine the request to provider routings and user experiences over time.

The descriptions below relate generally to the Standard Title Object Model, the Standard Escrow Object Model and the Standard Rates and Fees Object model of the present system 10. These models serve to create a consistent definition of Title Industry Standard Objects, which provide a consistent, object-oriented (aka Strongly Typed) structure to these objects. This structural representation is used in a majority of the Title Industry business processes and transactions and serves to transform transactions into serializable data and vice versa which enables effective integration, efficient transmission and transport, and a highly self-documenting data structure for API and SDK (Software Development Kit) implementors.

As shown in FIG. 2, a Unified Modeling Language (UML) class diagram illustrates the system processes of the standard title object model provided by the system 10. In particular, FIG. 2 shows the domain of system objects (classes) that make up the TISO model, the hierarchy among those objects and how they interact. The diagram also shows which objects serve as containers for other data objects.

The two smaller diagrams at the bottom of FIG. 2, titled “Legend” and “UML” explain the purpose of the various arrows and boxes that make up the diagram. Where applicable, these Legend and UML descriptors follow various other object diagrams throughout this document, for reference. It is to be understood that the diagraming technique, UML, is a common industry standard, which the reader is encouraged to reference as necessary.

The API-First Event Processing Flow section that follows shows a distributed computing scenario that can be used to create a Publisher-Subscriber interaction between applications, independent of industry, business entity or application platform over HTTPS (SSL) both asynchronously, and with durability. The queued nature of implementations means that transactions are never lost and all changes to the data model are immutable and versioned.

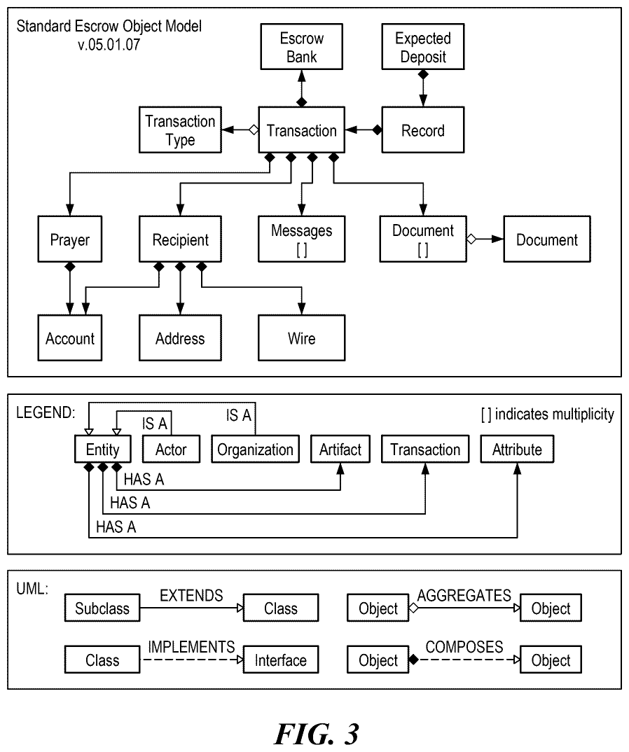

Now referring to FIG. 3, a UML class diagram illustrating the system processes of the Standard Escrow Object Model provided by the system 10 is shown. FIG. 3 provides further detail into the interdependencies of the TISO objects as they pertain to the escrow process, and in particular, payments, transactions and recipients of escrow. The diagram of FIG. 3 is meant to provide further detail into the ‘Escrow Bank” referenced in FIG. 2.

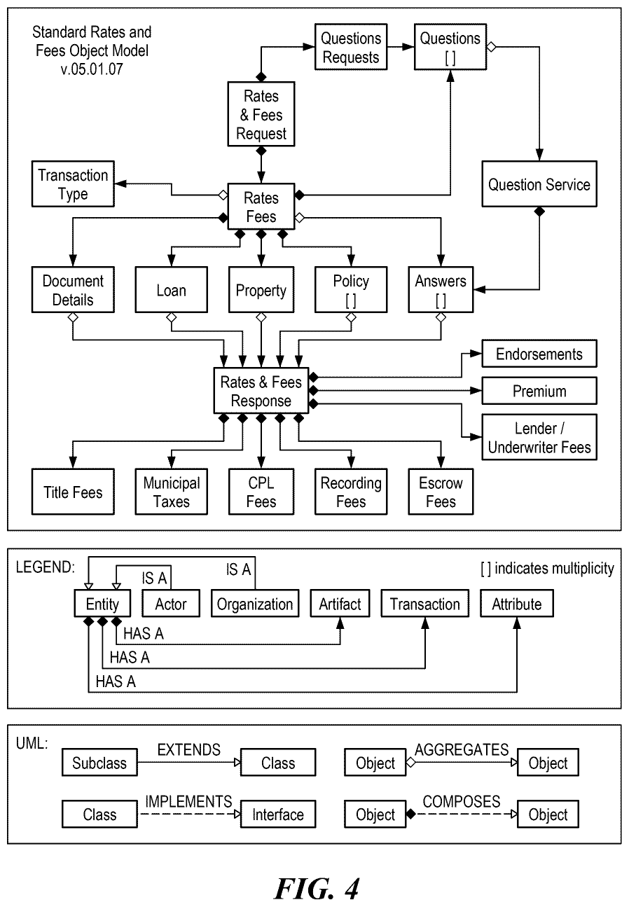

Now referring to FIG. 4, a UML class diagram illustrating the system processes of the Standard Rates and Fees Object Model provided by the system 10 is shown. The system 10 will accept ‘Rate and Fee’ requests for various types of products and services. Based on the type of request, the invention will create Rate and Fee Response(s) to be returned to the requestor. A Question service also exists to facilitate general requests.

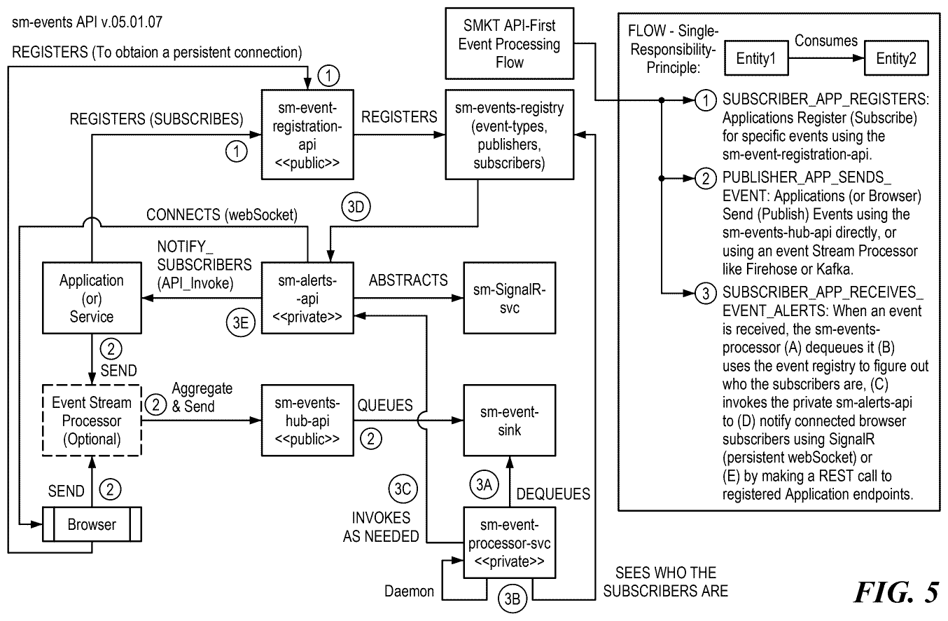

Now referring to FIG. 5, a UML interaction diagram illustrating the system processes of the System Events Object Model provided by the system 10 to enable asynchronous distributed processing among disparate systems across organizational boundaries using Advanced Message Queuing Protocol (AMQP) is shown. AMQP guarantees delivery while enabling systems' resiliency through eventual consistency using the Command Query Responsibility Segregation (CQRS) pattern. FIG. 5 shows the flow of consumer requests using a publish/subscribe (aka pub-sub) methodology. The flow of the various pub-sub steps is detailed in the diagram and each step is explained in the legend provided at the top of the diagram of FIG. 5.

In addition to the Standard API's, the system 10 enables integration with multiple third-party systems in the industry using a modern, distributed event-driven model which enables client applications to both publish and subscribe to specific events to achieve asynchronous integration with a high degree of scalability as indicated by FIG. 5. The integration is design to support clients that are actively connected to the services and waiting for a workload to complete using a persistent TCP/IP connection for clients that require the synchronous experience. For clients that want to fire-and-forget with true asynchrony in their process flows, the client can simply submit the event and can either get called when the processing is completed, or can subscribe to the resulting events as shown in FIG. 5.

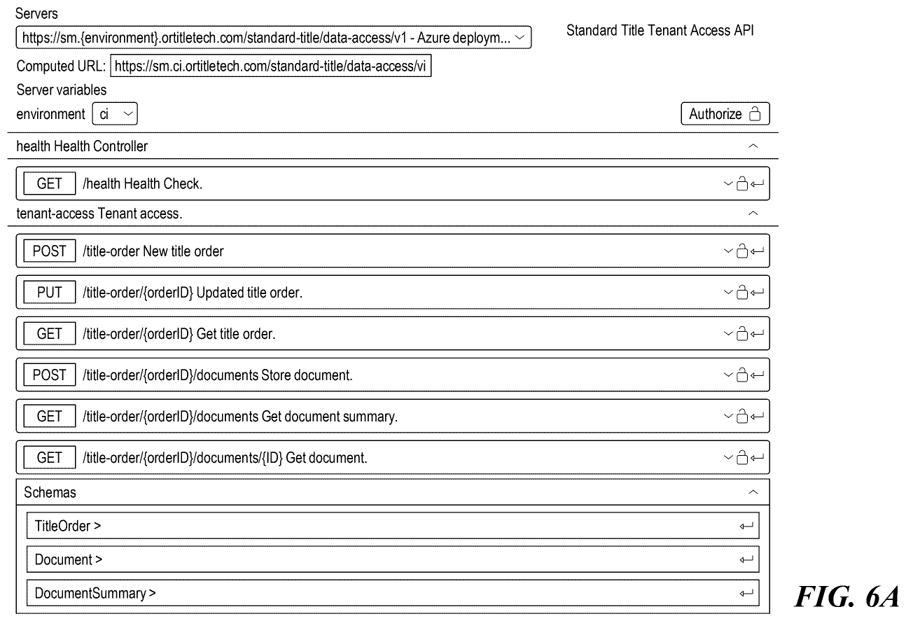

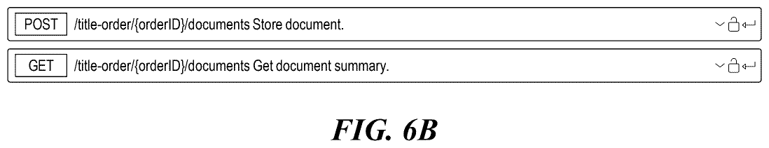

Now referring to FIGS. 6A-6B, according to one or more embodiments, applications may access TISO implementations via integration to direct data exchange API calls or by consuming micro-UI fragments delivered by a TISO API. For example, a TISO “Standard Rates and Fees” API may support API calls to retrieve rates and fees given a request payload containing property details. FIG. 6A shows the Swagger UI, which documents the available API functions and how they should be called. It may also provide micro-UI to support user interaction in receiving user input data and supplying the request to retrieve products and services from providers.

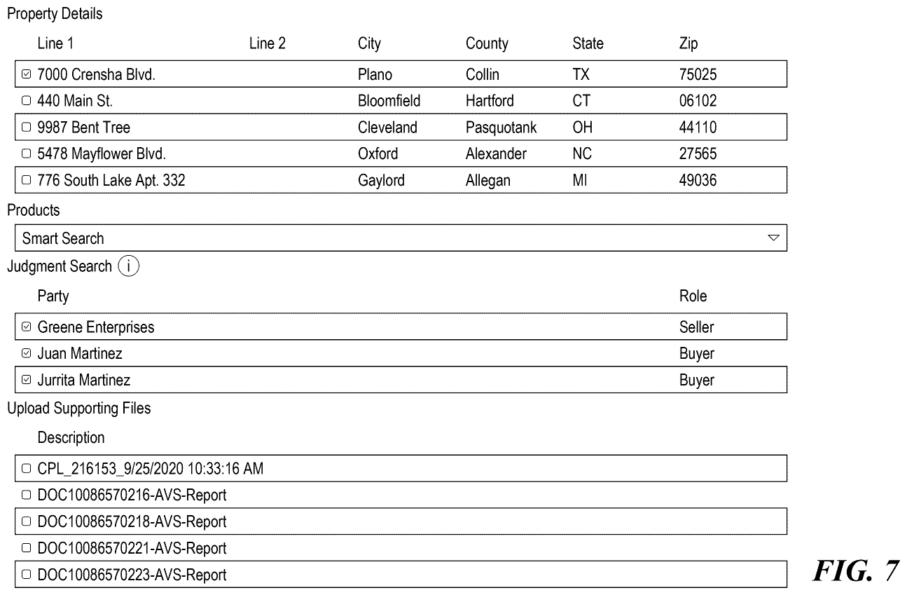

Now referring to FIG. 7, a UI implementation of a Standard Title integration provided by the system 10 is shown. As is illustrated in FIG. 7, title order data can be sent to the integration in the form of a Standard Title Order object. That data is used by the system 10 to generate the UI specifics. The data collected from this UI, along with the title order data, is merged into a Standard Title Order object and sent to a vendor as a service request. The vendor then returns the service request to the API using the same Standard Title Order object schema.

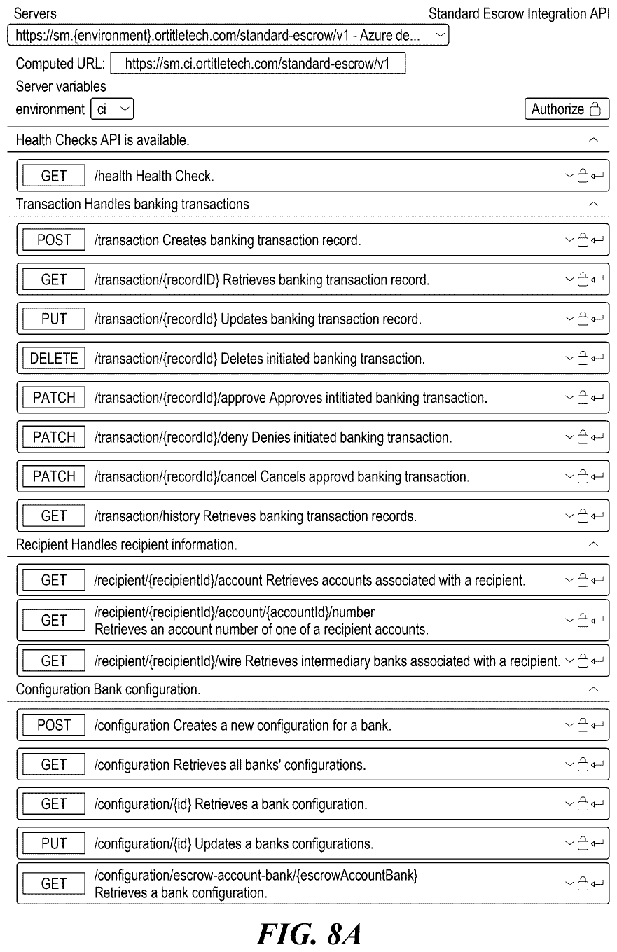

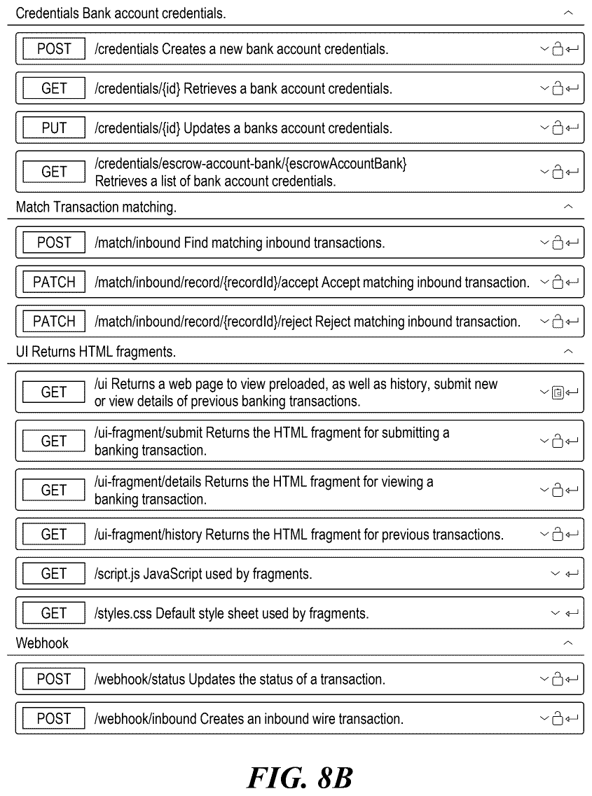

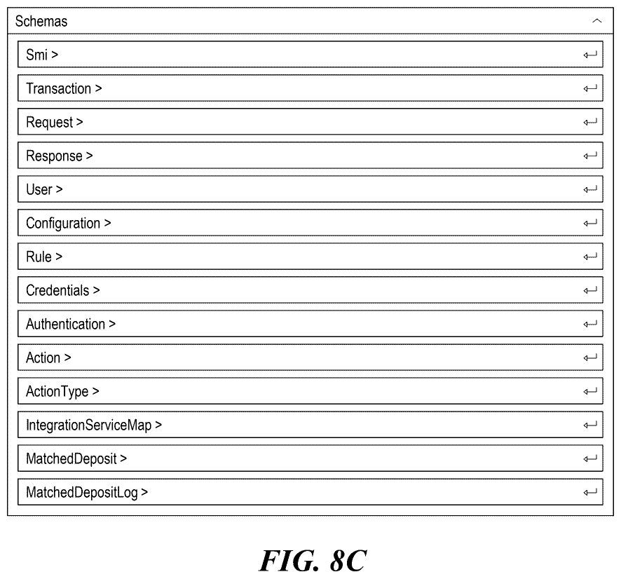

FIGS. 7, 8A, 8B, and 8C show an example API definition using REST standards to facilitate banking transactions backed by the Standard Escrow Data Object provided by the system 10. The API provides endpoints to initiate, approve, match and track these transactions as well as endpoints to provide configuration and micro-UI for the consumer. As shown in FIG. 8C, a view of the top-level properties of the schema used in the banking transactions provided by the Standard Escrow integration is provided.

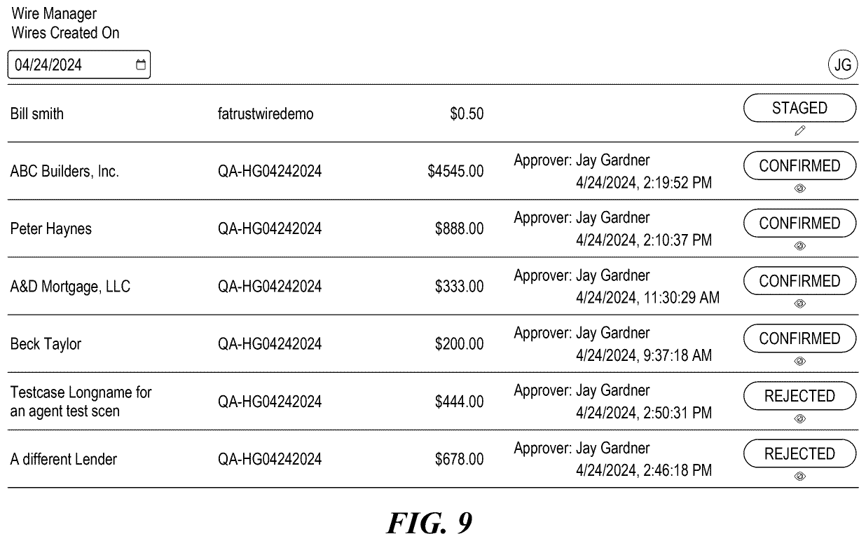

Now referring to FIG. 9, a micro-UI implementation for the Standard Escrow Wire Manager transaction view is shown. This UI will use the available API to allow users interaction with the in-process transactions.

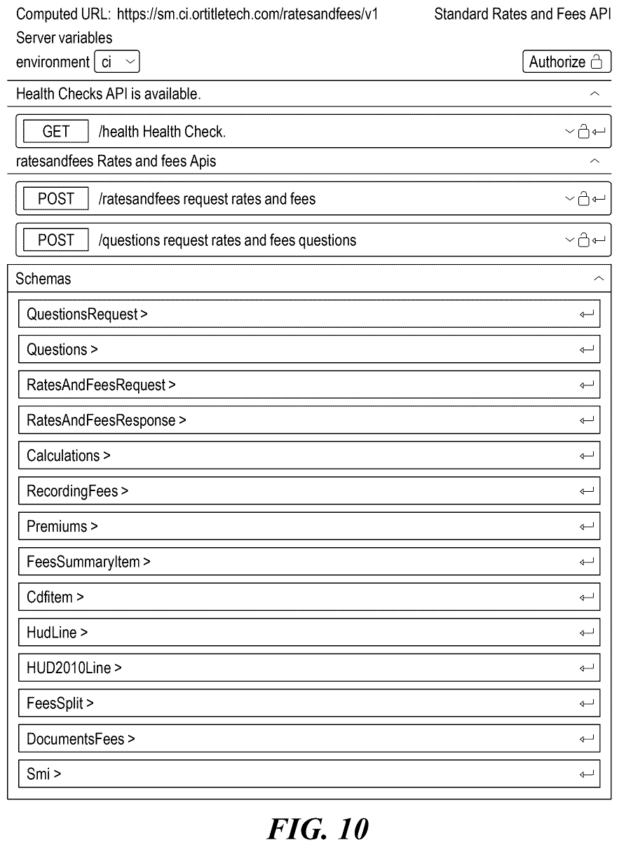

FIG. 10 shows an example API definition using REST standards to facilitate the Standard Rates and Fees model as well as a list of schema used in those requests.

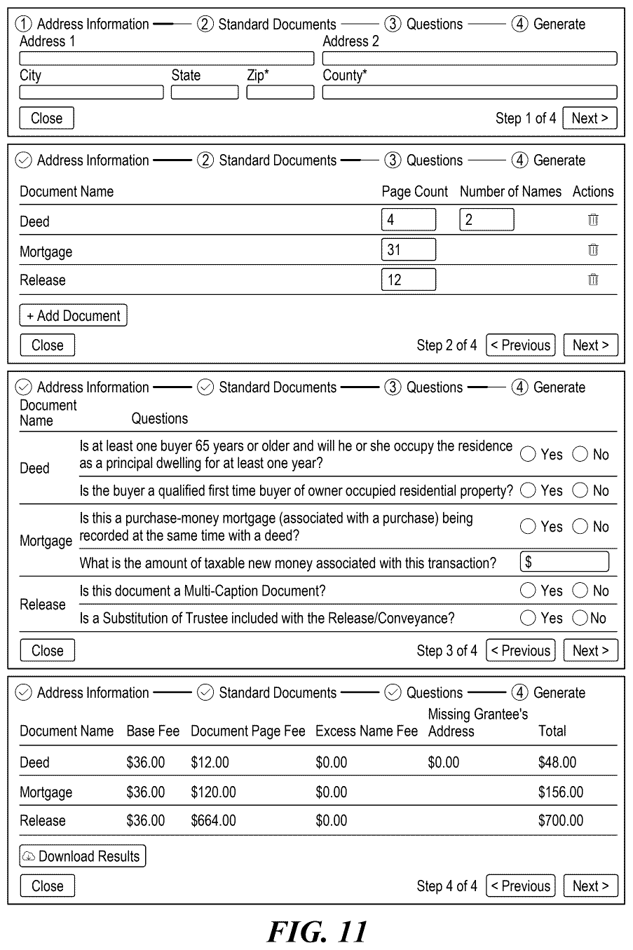

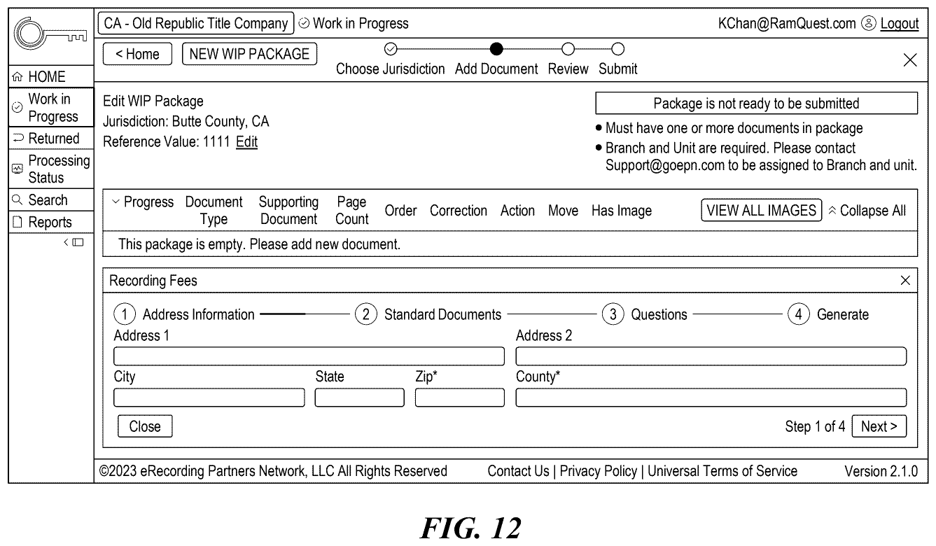

FIGS. 11 and 12 show an implementation of the micro-UI that allows a consumer to interact with the Rates and Fees API. This UI will help the consumer build their request without having to understand the Rates and Fees data objects that back the API.

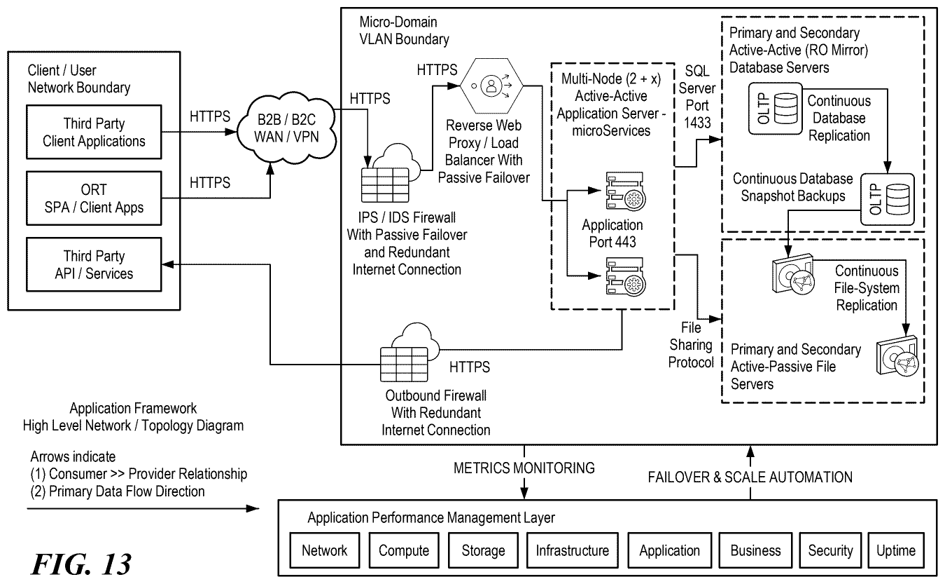

Now referring to FIG. 13, a data center infrastructure-as-a-service (IaaS) implementation of the system 10 is shown. The IaaS implementation comprises a client/user network boundary that comprises third party client applications, third party API/services, and host SPA/client applications. The third-party client applications and host SPA/client applications are in communication with a Micro-Domain VLAN Boundary via B2B/B2C/WAN/VPN networks and HTTPS protocol. The Micro-Domain VLAN Boundary comprises an IPS/IDS firewall with passive fallover and redundant internet connection, a reverse web proxy or load balancer with passive fallover, a multi-node (2+x) active-active application server. The multi-node (2+x) active-active application server may be communication with an outbound firewall with redundant internet connection and the third party API/services via HTTPS protocol. Additionally, the multi-node (2+x) active-active application server is in communication with a primary and secondary active-active (RO Mirror) database services, and primary and secondary active-passive file servers (SAN) via SQL server port 1433 and file sharing protocol, respectively.

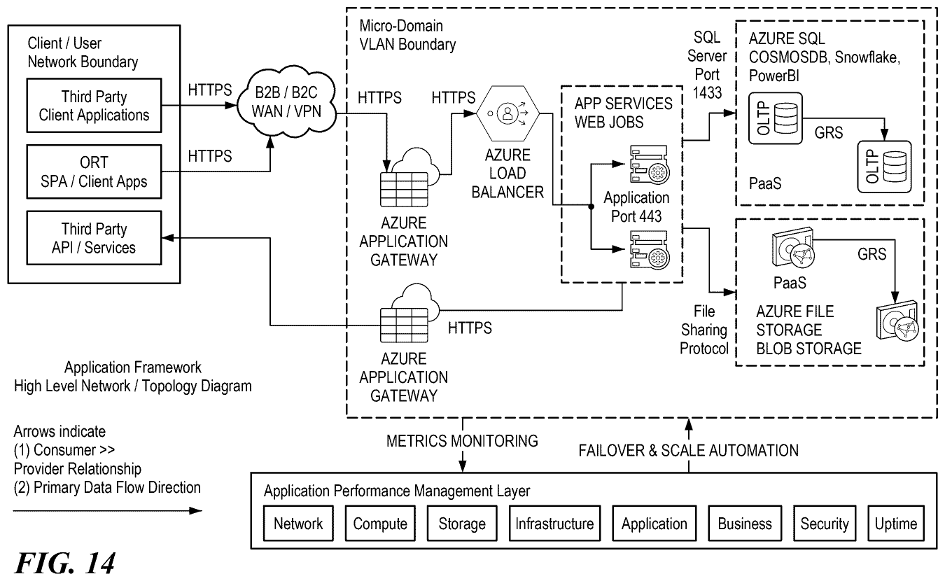

Now referring to FIG. 14, a platform-as-a-service (PaaS) implementation compatible with a cloud platform, such as Microsoft Azure, is shown. The IaaS implementation comprises a client/user network boundary that comprises third party client applications, third party API/services, and host SPA/client applications. The third-party client applications and host SPA/client applications are in communication with a Micro-Domain VLAN Boundary via B2B/B2C/WAN/VPN networks and HTTPS protocol. According to one or more embodiments, the Micro-Domain VLAN Boundary comprises an Azure application gateway, load balancer, and Azure services web jobs-which can then be in communication with Azure SQL COSMOSDB, Snowflake, PowerBI and Azure file storage BLOB storage via SQL server port 1433 and file sharing protocol, respectively.

According to one or more embodiments, a single version of the truth for data and information process flows across all title processing platforms. As used herein, “truth for data” or “truthful data” refers to a single accepted format and definition for real estate transaction title and escrow data, which serves as a single source of truth (SSoT). Title work associated with a real estate transaction goes through several steps and processes from creation to closing, typically involving multiple service providers exchanging data electronically (e.g., a title company issues owner's and lender's title insurance policies, another title service company provides a tax certificate document, another closing service provider provides digital closing services, and a real estate document recording service provider electronically records the deed with the county recorder). By exchanging information amongst these providers housed in a standard data object, there is a single accepted format and definition for the real estate transaction title and escrow data.

According to one or more embodiments, the system 10 includes a Standardized API-First, versioned Object model that enables the present system to provide well-documented implementations across technology stacks using the OpenAPI Standards (OAS) to enable integration partners to easily access the documentation and reduce learning curve. This is because the standard object definitions include the structure, format, node/element/attribute names and data types along with the data. By standardizing on JavaScript Object Notation (JSON) objects, the field definitions and populated data must all be encoded such that these objects may be exchanged as strings and therefore automatically compatible across computing technology stacks. Therefore, there is no need to implement consuming applications or service providers with a specific technology, e.g., Microsoft.net or Java, or require specific object serialization/deserialization libraries.

According to one or more embodiments, the system 10 can avoid redundant implementation across systems by consolidating business processes, data structures and workflow compliance. By creating a standard set of objects for the Title domain, consumers have no need to implement their own object versions. The system provides for easy adoption of these object models, since they exist as JSON objects. Similarly, the services exposed have common utility across the Title industry, limiting custom development efforts on the part of the consumer.

According to one or more embodiments, Unified OpenID-Connect compliant Authentication and Authorization of the system 10 may provide both Role-Based and Tenancy-based Access Control mechanisms with fine-grained control. These may include standards-based access and role/permissions security mechanisms for consuming applications and providers, supporting user credentials and API keys. The system's API layer may utilize authentication and authorization products such as KeyCloak™ to allow single sign-on with identity management, and implement application and tenant (application instance deployed for a specific customer) roles and permissions, and can federate with and digitally trust other authentication and authorization systems that use the same standards, such as Okta™, OneLogin™, Ping™, etc.

According to one or more embodiments, the system 10 may require future changes, to support new functional enhancements, evolving industry requirements, and regulatory changes. These changes will be implemented using industry-accepted versioning standards, to ensure future enhancements are non-breaking. According to one or more embodiments, the system may provide a unified user experience to business administrators (tenant-level and platform-level administration). and users across system and organizational boundaries. A tenant-level business administrator may work at a company providing title services (e.g., title insurance policies, searches, notary signing services) or supporting the title production process (a title closing company utilizing title production software such as RamQuest or Qualia). The business administrator may define and implement their own processes, a subset of which will be based on required data exchanges with industry partners. A business administrator may find value in selecting and configuring integrations with partners that support exchanging standard data objects, as this will reduce the cost and complexity of their overall solution, and allow flexibility to more easily switch providers without incurring high technology and user re-training costs.

End users of any such tenancy-based system(s), e.g., title production software, may benefit from consistent data entry across integration partners via standard data entry and UI fragments—for example, users can submit a request using their title production software and then the users do not need to know or care which underlying recording fee service provider was selected by the decision engine to receive the request. In some situations, the request can be sent to multiple providers to get a successful response. However, the user will only be presented with the data that is automatically populated back into the user's application.

According to one or more embodiments, the present system 10 enables transparent integration with both external and internal data service providers using event-driven microservices patterns that enable self-service. The TISO standards facilitate integrations between title industry systems, whether they are company internal (e.g., integrating multiple internal systems with each other) or external (integrating cross-company amongst industry partners). The standards are published and shared, which enables self-service development by any entity wanting to publish or consume an internal or external service. By implementing the standards, a provider may publish a service they know will be automatically consumable by a subscriber. A subscribing application may develop a single integration point codebase that may be leveraged to consume multiple integrated services without directly interacting with those service providers.

According to one or more embodiments, the system 10 may provide standardized common industry integrations to streamline onboarding and promote rapid adoption of functionality. This is because when industry providers implement the standard objects and associated APIs, integration work to onboard a new provider is reduced to a configuration exercise for the consuming applications-provide security credentials and configure the provider's endpoints. All development (coding) work is completed one time by the service provider and all applications that have also implemented the standards can rapidly onboard that service provider via configuration and testing only.

According to one or more embodiments, the system 10 leverages the OpenAPI Specification (OAS) to enable a language-independent and platform-independent interface to objects and HTTP APIs. OAS is not tied to any specific programming language or platform. It can be used to define APIs in any language, and clients/consumers can be developed in any language and on any platform that can access those APIs.

According to one or more embodiments, the system 10 exposes key user interfaces (UIs) as embeddable fragments within HTML, CSS, and JS applications to eliminate rework and improve time-to-functionality with out-of-the-box UI capability. These ‘Micro-frontends’ can be used within various consumer UIs. The consumer's UI development team is thereby enabled to work on various components concurrently, minimizing delays and conflicts.

According to one or more embodiments, the system 10 may provide event-driven webhook functionality that enables applications to both publish and subscribe to multi-phase transactions and resulting events with fire-and-forget reliability, persistent queues, and recoverability. Information providers implement endpoints that will accept incoming request calls from consuming applications (“web hooks”) that require specific responses from the provider. Request may be completed synchronously, i.e., the service provider immediately returns the requested data in responding to the web hook call, or asynchronously, in which case the provider responds to the request call indicating that the request has been received and that the requested product or service will be returned in the future. The standard API may include provider-initiated incoming calls for these future responses and also new requests coming in from the provider. Responses and incoming requests may trigger standard events, which are published to and consumed by subscribers (applications) that need to be notified. These events may then be used to drive business workflows in subscribing applications. For example, a request for a title search is sent to a provider via web hook call. The title search provider can respond with “200/ok”. An hour later, the title search provider generates and transmits an API call to send back the title search results, populating the title order data object with relevant results data and also attaching a .pdf document summarizing the results, and receiving an “200/ok” back. The data and document are then persisted by the system 10 so that the provider may “forget”, and an event is published to let consuming applications know that the results are available. The consuming application then makes a call to retrieve the results and their request is now fulfilled. The request and response data may be preserved, retained and recovered in the future, based on business and regulatory requirements.

According to one or more embodiments, the system 10 can provide fully functional out-of-the-box implementation with the ability to customize through configuration without the need for code changes. Specifically, typical site-specific settings are able to be set via application setting and/or configuration files, rather than requiring a formal development cycle to customize functionality.

According to one or more embodiments, the system 10 can provide decision engines to facilitate optimized, real-time service provider selection and interaction leveraging machine learning, hierarchical configuration, confidence scoring, and “smart” customer-driven defaults. The decision engine maps outgoing requests with the optimal service provider, given criteria such as service provider geographic coverage, service provider response times, response/results accuracy and quality based on consumer feedback, price, and customer preference. The decision engine maintains and provides confidence scores in mapping requests to providers and evaluating the responses and “learns” to further optimize over time as similar requests come through the system.

According to one or more embodiments, the system 10 may provide a centralized identity management platform with the ability to federate authentication to larger organizations that already have an established identity platform. One common approach would be to use Single Sign-On (SSO) as the method of federation, but not the exclusive method.

According to one or more embodiments, the system 10 may provide the implementation of password complexity, multi-factor authentication, credential lifecycle and other identity governance and administration controls in an industry-standard OpenID connect (OIDC) platform which enables self-service provisioning and administration. Specifically, the system 10 facilitates OIDC, which allows the consumer to implement and enforce these security measures.

According to one or more embodiments, the system 10 may provide the ability to secure data both at rest and during transfer using industry-standard data-loss-prevention frameworks. It is to be understood that there are multiple techniques for securing data at rest and in transit. Implementations of the standard objects and associated APIs must also offer industry standard data security. Our implementation uses SSL/TSL to secure data during transport and encryption (AES and SHA) to secure data at rest in data stores.

According to one or more embodiments, the system 10 may provide a reporting platform around record system usage, transactional history, and system performance for authorized users.

According to one or more embodiments, the system 10 may provide the ability to send out key system and event notifications to subscribers using standard events, email, and SMS text messaging to enable human intervention and automation.

According to one or more embodiments, the system 10 may provide billing controls implemented to enable metered provisioning of transactions and API consumption to drive commercial monetization when needed.

According to one or more embodiments, the system 10 may provide event-driven auto-scaling and geo-redundant failover across multiple cloud data centers to leverage the elasticity, recoverability, and availability of the cloud.

According to one or more embodiments, the system 10 may provide a developer-first experience with testable, self-documenting Web APIs that enable test-automation and code-first exploratory and test-driven implementations.

According to one or more embodiments, the system 10 may provide asynchronous, message-driven persistent queue architecture that creates an immutable replayable record of transactions for both redundancy and auditability.

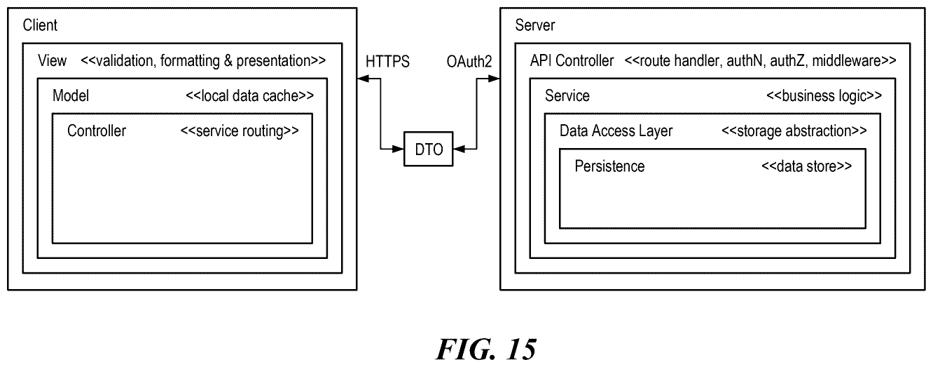

Now referring to FIG. 15, an exemplary system constructed in accordance with principles of the present application is shown. In some embodiments, the system 10 comprises a client or host computing device that is configured to communicate with the server via HTTPS to perform the various functions and capabilities described herein.

According to one or more embodiments, the system 10 can also comprise an online network and host computing device having hardware and software configured to enable the computing device to host an application platform for standardized data objects and processes for transferring property rights and closing real estate transactions. The hardware may include processing circuitry, which may include a processor and a memory. In particular, in addition to or instead of a processor, such as a central processing unit and memory, the processing circuitry may include integrated circuitry for processing and/or control, e.g., one or more processors and/or processor cores and/or FPGAs (Field Programmable Gate Array) and/or ASIC's (Application Specific Integrated Circuitry) adapted to execute instructions. The processor may be configured to access (e.g., write to and/or read from) the memory, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Further, memory may be configured as a storage device.

The processing circuitry may be configured to control any of the methods and/or processes described herein and/or to cause such methods and/or processes to be performed by the system. Processor corresponds to one or more processors for performing the system functions described herein. In some embodiments, the software may include instructions that, when executed by the processor and/or processing circuitry, causes the processor and/or processing circuitry to perform the processes described herein with respect to the system.

The software may be stored internally in, for example, memory, or stored in external memory (e.g., database, storage array, network storage device, etc.) and accessible via an external connection. The software may be executable by the processing circuitry.

According to one or more embodiments, the host computing device is in communication with one or more data repositories or information providers via one or more online networks. The networks may be configured to provide communication, e.g., wired and/or wireless communication between components of the system, e.g., between the host computing device and each information provider. As used herein, “information providers” may refer to service providers who provide one or more of the following: title searches, tax certificates, surveys, closing protection letters, lien searches, and the like.

The systems and methods described herein can be executable by application software and/or can be web-based software programmed, designed, or otherwise capable of being run on the host computing device having the hardware and software components necessary to store and/or run the application and/or web-based software. In one or more embodiments, the host computing device may be a desktop computer, laptop, tablet, mobile device, such as a smart phone, or other smart device.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques).

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

Having thus described the invention of the present application in detail and by reference to embodiments thereof, it will be apparent that modifications and variations are possible without departing from the scope of the invention defined in the appended claims as follows:

We claim:

1. A standardized title processing system, comprising:
a host computing device;
a digital platform for standardized data objects and processes for transferring information associated with real property, the digital platform being hosted by the host computing device;
one or more provider computing devices each being in communication with the host computing device and the digital platform via one or more networks; and
wherein the host computing device is configured to:
submit a request for information to the one or more provider computing devices;
receive a response from each of the one or more provider computing devices with the requested information;
analyze a current standard of the retrieved information;
translate the retrieved information into a single standardized format; and
generate a report comprising the translated information.

2. The system of claim 1, wherein the one or more provider computing devices are in each communication with a respective database storing information related to real property.

3. The system of claim 1, wherein the host computing device submits the request for information to each of the one or more provider computing devices via an API call.

4. The system of claim 2, wherein the stored information related to real property comprises at least one of: chain of title information, tax records, appraisal details, legal records, title information, escrow information, fee information, and events.

5. The system of claim 1, wherein the digital platform further comprises a search engine configured to facilitate the exchange of API calls over the one or more networks.

6. The system of claim 1, wherein the host computing device further comprises a decision engine module programmed to filter the exchange of standardized information to users.

7. The system of claim 1, wherein the digital platform is one of: an application-based platform and a web-based platform.

8. The system of claim 1, wherein the request for information comprises a request for Rate and Fee information associated with a vendor of real estate services.

9. The system of claim 1, wherein the digital platform is programmed to be integrated with third-party real estate closing platforms.

10. The system of claim 1, wherein the digital platform uses one or more application programming interfaces to send and receive API calls to transmit information between the host computing device and the one or more provider computing devices.

11. The system of claim 1, wherein the single standardized format is a single source of truth (SSoT).

12. A method for generating standardized title reports using information from a plurality of independent information sources, comprising:
providing a host computing device;
accessing, with the host computing device, a digital platform for standardized data objects and processes for transferring information associated with real property;
submitting a request for information to one or more data sources;
receiving a response from at least one computing device associated with the one or more data sources, the response including the requested information;
analyzing a current standard of the requested information contained within the response;
translating the requested information into a single standardized format; and
generating a title report comprising the translated requested information.

13. The method of claim 12, wherein the request is submitted via an API call.

14. The method of claim 12, wherein the one or more data sources comprise one or more information providers.

15. The method of claim 12, wherein translating the requested information into a single standardized format comprises encoding the requested information as data strings compatible with one or more technology stacks.

16. The method of claim 12, wherein the host computing devices comprises one of a desktop computer, laptop, tablet, and mobile device.
